(19) United States
(12) Patent Application Publication
(10) Pub. No.: US 2007/0138382 A1
(43) Pub. Date: Jun. 21, 2007

(54) Optical encoder

(75) Inventor: Hiroshi Matsuyama, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/638,467

(22) Filed: Dec. 14, 2006

(30) Foreign Application Priority Data
Dec. 19, 2005 (JP) 2005-364496

(51) Int. Cl. G01D 5/34

(52) U.S. Cl. 250/231.13

(57) ABSTRACT

An optical encoder with improved resolution without narrowing either a slit pitch or a width in a moving direction of a light-receiving element is provided. A light-receiving block on a first row in a direction perpendicular to the moving direction is provided with four light-receiving elements 3 (A[1], B[1], A′[1], B′[1]) and a light-receiving block on a second row is provided with four light-receiving elements 3 (A[2], B[2], A′[2], B′[2]). The shape of each light-receiving element 3 is identical (width in the moving direction is approximately P/4 and width in the direction perpendicular to the moving direction is approximately W/2). The position of the light-receiving block on the second row in the direction perpendicular to the moving direction is shifted by P/8 in the moving direction and by W/2 in the direction perpendicular to the moving direction relative to the light-receiving block on the first row.

The present application is based on and claims priority of Japanese patent application No. 2005-364496 filed on Dec. 19, 2005, the entire contents of which are hereby incorporated by reference.

### BACKGROUND OF THE INVENTION

1. Field of the Invention

The present invention relates to an optical encoder for measuring the amount of displacement in a direction of rotation or rectilinear direction.

2. Description of the Related Art

An optical encoder is used in a wide range of fields for controlling the speed, direction and position of a rotary motion and rectilinear motion.

Conventionally, there is a proposal of an optical encoder which outputs 2 pulses for a 1-slit pitch movement as shown in FIG. 2 of Japanese Patent Laid-Open Publication No. 59-040258 (patent document 1). FIG. 12 shows the structure of this optical encoder and FIG. 13 shows signals outputted (“T” in the signal at the bottom of FIG. 13 denotes a time required for 1-slit pitch movement, during which two pulses are outputted). To improve resolution of such an optical encoder, there is no other way than narrowing the slit pitch. However, it is difficult to print a narrow slit and it is especially difficult to improve resolution with the optical encoder described in patent document 1.

FIG. 12 in Japanese Patent Laid-Open Publication No. 61-292016 (patent document 2) discloses a technology of improving resolution without changing a slit pitch by narrowing the width in a direction in which the light-receiving element is moved. FIG. 14 shows the structure of this optical encoder and FIG. 15 shows signals outputted. In FIG. 13 (optical encoder of patent document 1), two pulses are outputted during the period T, while in FIG. 15 (optical encoder of patent document 2), three pulses are outputted during the period T and it is possible to improve resolution.

However, according to the technology described in patent document 2, there is a problem that it is necessary to narrow the width in the moving direction of the light-receiving element and working upon the light-receiving element becomes more and more difficult as resolution improves.

### SUMMARY OF THE INVENTION

The present invention has been implemented in view of the above described problems and it is an object of the present invention to provide an optical encoder which outputs more signals of different phases than the conventional one with improved resolution without narrowing either the slit pitch or the width in the moving direction of a light-receiving element.

The optical encoder according to a first aspect of the present invention is an optical encoder which causes a moving section provided with a plurality of slits to pass between a light-emitting section and light-receiving section which are arranged opposite to each other and detects movement information on the moving section, wherein the plurality of slits are formed so as to have a width of P/2 in a moving direction and a width of W in a direction perpendicular to the moving direction every predetermined pitch P in the moving direction, when it is assumed that I is an integer of 1 or greater, J is an integer of 1 or greater and I×J≠1, the light-receiving section comprises (I×J) light-receiving blocks arranged on I rows in the moving direction and J rows in the direction perpendicular to the moving direction, when M is assumed to be an integer of 1 or greater, each light-receiving block comprises a first light-receiving element group made up of M light-receiving elements arranged every predetermined pitch P in the moving direction, a second light-receiving element group made up of M light-receiving elements arranged close to the M light-receiving elements of the first light-receiving element group at respective positions shifted by P/4 in the moving direction from the M light-receiving elements of the first light-receiving element group, a third light-receiving element group made up of M light-receiving elements arranged close to the M light-receiving elements of the second light-receiving element group at respective positions shifted by P/4 in the moving direction from the M light-receiving elements of the second light-receiving element group, a fourth light-receiving element group made up of M light-receiving elements arranged close to the M light-receiving elements of the third light-receiving element group at respective positions shifted by P/4 in the moving direction from the M light-receiving elements of the third light-receiving element group, all the light-receiving elements of the optical encoder have an identical shape with a width in the moving direction being approximately P/4 and a width in the direction perpendicular to the moving direction being approximately W/J, all the light-receiving element groups of the optical encoder output signals obtained by adding up output signals of the M light-receiving elements making up the light-receiving element groups, and each light-receiving block is arranged at a position shifted in such a way that the phases of output signals of all the light-receiving element groups of the optical encoder differ from each other.

According to the optical encoder according to the first aspect of the present invention, the plurality of light-receiving blocks are arranged at positions shifted so that the output signals of the respective light-receiving element groups have different phases from each other, and therefore it is possible to output more signals of different phases than the conventional one. Furthermore, when M is 2 or greater, it is possible to increase the light-receiving area equivalently and reduce influences of noise or the like by making up each light-receiving element group using a plurality of light-receiving elements which output signals of the same phase.

The optical encoder according to a second aspect of the present invention is an optical encoder which causes a moving section provided with a plurality of slits to pass between a light-emitting section and light-receiving section which are arranged opposite to each other and detects movement information on the moving section, wherein the plurality of slits are formed so as to have a width of P/2 in a moving direction and a width of W in a direction perpendicular to the moving direction every predetermined pitch P in the moving direction, when J is assumed to be an integer of 2 or greater, the light-receiving section comprises J light-receiving blocks arranged on one row in the moving direction and J rows in the direction perpendicular to the moving direction, when M is assumed to be an integer of 1 or greater, each light-receiving block comprises a first light-receiving element group made up of M light-receiving elements arranged every predetermined pitch P in the moving direction, a second light-receiving element group made up of M light-receiving elements arranged close to the M light-receiving elements of the first light-receiving element group at respective positions shifted by P/4 in the moving direction from the M light-receiving elements of the first light-receiving element group, a third light-receiving element group made up of M light-receiving elements arranged close to the M light-receiving elements of the second light-receiving element group at respective positions shifted by P/4 in the moving direction from the M light-receiving elements of the second light-receiving element group, a fourth light-receiving element group made up of M light-receiving elements arranged close to the M light-receiving elements of the third light-receiving element group at respective positions shifted by P/4 in the moving direction from the M light-receiving elements of the third light-receiving element group, all the light-receiving elements of the optical encoder have an identical shape with a width in the moving direction being approximately P/4 and a width in the direction perpendicular to the moving direction being approximately W/J, all the light-receiving element groups of the optical encoder output signals obtained by adding up output signals of the M light-receiving elements making up the light-receiving element groups, and when j is assumed to be an integer of 2 or greater and not greater than J, a jth light-receiving block is arranged at a position shifted by (j−1)×P/(4×J) in the moving direction relative to the first light-receiving block.

According to the optical encoder according to the second aspect of the present invention, it is possible to output more signals of different phases than the conventional one by arranging a plurality of light-receiving blocks at positions calculated based on the phases of output signals of the respective light-receiving element groups (when it is assumed that j is an integer of 2 or greater and not greater than J and h is an integer of 1 or greater and not greater than 4, the amount of shift of the jth light-receiving block in the moving direction of the hth light-receiving element group is obtained by adding the amount of shift of the hth light-receiving element group to the expression expressing the amount of shift in the moving direction according to the second aspect of the present invention as (J×(h−1)+j−1)×P/(4×J). Here, if it is assumed that the hth light-receiving element group of the jth light-receiving block is expressed as a “gth light-receiving element group” as g=J×(h−1)+j, this mapping uniquely gives integers from 1 to (4×J) to all (4×J) light-receiving element groups. In this case, the phase of the output signal of the gth light-receiving element group becomes ((g−1)/(4×J)) times one period from the above described two expressions. That is, it is possible to obtain (4×J) output signals of the same phase interval). Moreover, when M is 2 or greater, it is possible to increase the light-receiving area equivalently and reduce influences of noise or the like by making up each light-receiving element group using a plurality of light-receiving elements which output signals of the same phase.

The optical encoder according to a third aspect of the present invention is an optical encoder which causes a moving section provided with a plurality of slits to pass between a light-emitting section and light-receiving section which are arranged opposite to each other and detects movement information on the moving section, wherein the plurality of slits are formed so as to have a width of P/2 in a moving direction and a width of W in a direction perpendicular to the moving direction every predetermined pitch P in the moving direction, when I is assumed to be an integer of 2 or greater, the light-receiving section comprises I light-receiving blocks arranged on I rows in the moving direction and one row in the direction perpendicular to the moving direction, when M is assumed to be an integer of 1 or greater, each light-receiving block comprises a first light-receiving element group made up of M light-receiving elements arranged every predetermined pitch P in the moving direction, a second light-receiving element group made up of M light-receiving elements arranged close to the M light-receiving elements of the first light-receiving element group at respective positions shifted by P/4 in the moving direction from the M light-receiving elements of the first light-receiving element group, a third light-receiving element group made up of M light-receiving elements arranged close to the M light-receiving elements of the second light-receiving element group at respective positions shifted by P/4 in the moving direction from the M light-receiving elements of the second light-receiving element group, a fourth light-receiving element group made up of M light-receiving elements arranged close to the M light-receiving elements of the third light-receiving element group at respective positions shifted by P/4 in the moving direction from them light-receiving elements of the third light-receiving element group, all the light-receiving elements of the optical encoder have an identical shape with a width in the moving direction being approximately P/4 and a width in the direction perpendicular to the moving direction being approximately W, all the light-receiving element groups of the optical encoder output signals obtained by adding up output signals of the M light-receiving elements making up the light-receiving element groups, and when it is assumed that i is an integer of 2 or greater and not greater than I and f(i) is an arbitrary integer in an ith light-receiving block, the ith light-receiving block is arranged at a position shifted by f(i)×P+(i−1)×P/(4×I) in the moving direction relative to the first light-receiving block.

According to the optical encoder according to the third aspect of the present invention, it is possible to output more signals of different phases than the conventional one by arranging a plurality of light-receiving blocks at positions calculated based on the phases of output signals of the respective light-receiving element groups (when it is assumed that i is an integer of 1 or greater and not greater than I, f(i) is an arbitrary integer in the ith light-receiving block and h is an integer of 1 or greater and not greater than 4, the amount of shift of the ith light-receiving block in the moving direction of an hth light-receiving element group is obtained by adding the amount of shift of the hth light-receiving element group to the expression expressing the amount of shift in the moving direction according to the third aspect of the present invention as (I×(h−1)+4×I×f(i)+i−1)×P/(4×I). Here, if it is assumed that the hth light-receiving element group of the ith light-receiving block is expressed as a “gth light-receiving element group” as g=I×(h−1)+i, this mapping uniquely gives integers from 1 to (4×I) to all (4×I) light-receiving element groups. In this case, the phase of the output signal of the gth light-receiving element group becomes ((g−1)/(4×I)) times one period from the above described two expressions. That is, it is possible to obtain (4×I) output signals of the same phase interval). Moreover, when M is 2 or greater, it is possible to increase the light-receiving area equivalently and reduce influences of noise or the like by making up each light-receiving element group using a plurality of light-receiving elements which output signals of the same phase.

The optical encoder according to a fourth aspect of the present invention is an optical encoder which causes a moving section provided with a plurality of slits to pass between a light-emitting section and light-receiving section which are arranged opposite to each other and detects movement information on the moving section, wherein the plurality of slits are formed so as to have a width of P/2 in a moving direction and a width of W in a direction perpendicular to the moving direction every predetermined pitch P in the moving direction, when it is assumed that I is an integer of 1 or greater, J is an integer of 1 or greater and I×J≠1, the light-receiving section comprises (I×J) light-receiving blocks arranged on I rows in the moving direction and J rows in the direction perpendicular to the moving direction, when M is assumed to be an integer of 1 or greater, each light-receiving block comprises a first light-receiving element group made up of M light-receiving elements arranged every predetermined pitch P in the moving direction, a second light-receiving element group made up of M light-receiving elements arranged close to the M light-receiving elements of the first light-receiving element group at respective positions shifted by P/4 in the moving direction from the M light-receiving elements of the first light-receiving element group, a third light-receiving element group made up of M light-receiving elements arranged close to the M light-receiving elements of the second light-receiving element group at respective positions shifted by P/4 in the moving direction from the M light-receiving elements of the second light-receiving element group, a fourth light-receiving element group made up of M light-receiving elements arranged close to the M light-receiving elements of the third light-receiving element group at respective positions shifted by P/4 in the moving direction from the M light-receiving elements of the third light-receiving element group, all the light-receiving elements of the optical encoder have an identical shape with a width in the moving direction being approximately P/4 and a width in the direction perpendicular to the moving direction being approximately W/J, all the light-receiving element groups of the optical encoder output signals obtained by adding up output signals of the M light-receiving elements making up the light-receiving element groups, and when it is assumed that i is an integer of 1 or greater and not greater than I, j is an integer of 1 or greater and not greater than J and i×j≠1, the light-receiving block on an ith row in the moving direction and on a jth row in the direction perpendicular to the moving direction is arranged at a position shifted by ((4×I×M+1)×J×(i−1)+j−1)×P/(4×I×J) in the moving direction and by (j−1)×W/J in the direction perpendicular to the moving direction relative to the light-receiving block on the first row in the moving direction and on the first row in the direction perpendicular to the moving direction.

According to the optical encoder according to the fourth aspect of the present invention, it is possible to output more signals of different phases than the conventional one by arranging a plurality of light-receiving blocks at positions calculated based on the phases of output signals of the respective light-receiving element groups (when it is assumed that i is an integer of 1 or greater and not greater than I, j is an integer of 1 or greater and not greater than J and h is an integer of 1 or greater and not greater than 4, the amount of shift of the hth light-receiving block on the ith row in the moving direction and on the jth row in the direction perpendicular to the moving direction is obtained by adding the amount of shift of the hth light-receiving element group to the expression expressing the amount of shift in the moving direction according to the fourth aspect of the present invention as (I×J×(h−1)+(4×I×M+1)×J×(i−1)+j−1)×P/(4×I×J). Here, if it is assumed that the hth light-receiving element group of light-receiving blocks on the ith row in the moving direction and on the jth row in the direction perpendicular to the moving direction is expressed as a “gth light-receiving element group” as g=I×J×(h−1)+J×(i−1)+j, this mapping uniquely gives integers from 1 to (4×I×J) to all (4×I×J) light-receiving element groups. In this case, the phase of the output signal of the gth light-receiving element group becomes ((g−1)/(4×I×J)) times one period from the above described two expressions. That is, it is possible to obtain (4×I×J) output signals of the same phase interval). Moreover, when M is 2 or greater, it is possible to increase the light-receiving area equivalently and reduce influences of noise or the like by making up each light-receiving element group using a plurality of light-receiving elements which output signals of the same phase.

The optical encoder according to a fifth aspect of the present invention is the optical encoder according to any one of the first to fourth aspects of the present invention, wherein in each light-receiving block, “1” is set as a first decision value of the light-receiving block when a value obtained by subtracting an output signal of the third light-receiving element group from an output signal of the first light-receiving element group is positive and “0” is set otherwise, and “1” is set as a second decision value of the light-receiving block when a value obtained by subtracting an output signal of the fourth light-receiving element group from the output signal of the second light-receiving element group is positive and “0” is set otherwise, and a value obtained by XORing the first decision values and second decision values of all the light-receiving blocks is outputted.

According to the optical encoder according to the fifth aspect of the present invention, it is possible to output more signals of different phases than the conventional one and further output signals with more pulses than the conventional one from these signals of different phases and thereby improve resolution without narrowing either the slit pitch or width in the moving direction of the light-receiving element. Furthermore, it is possible to increase the light-receiving area equivalently and reduce influences of noise or the like by making up each light-receiving element group using a plurality of light-receiving elements which output signals of the same phase.

### BRIEF DESCRIPTION OF THE DRAWINGS

FIG. 1 illustrates a structure according to Embodiment 1;

FIG. 2 illustrates signals according to Embodiment 1, Embodiment 3 and Embodiment 6;

FIG. 3 illustrates a structure according to Embodiment 2;

FIG. 4 illustrates signals according to Embodiment 2 and Embodiment 4;

FIG. 5 illustrates a structure according to Embodiment 3;

FIG. 6 illustrates a structure according to Embodiment 4;

FIG. 7 illustrates a structure according to Embodiment 5;

FIG. 8 illustrates signals according to Embodiment 5, Embodiment 6 and Embodiment 7;

FIG. 9 illustrates a structure according to Embodiment 6;

FIG. 10 illustrates a structure according to Embodiment 7;

FIG. 11 illustrates a structure according to Embodiment 8;

FIG. 12 illustrates the structure of an optical encoder according to Japanese Patent Laid-Open Publication No. 59-040258;

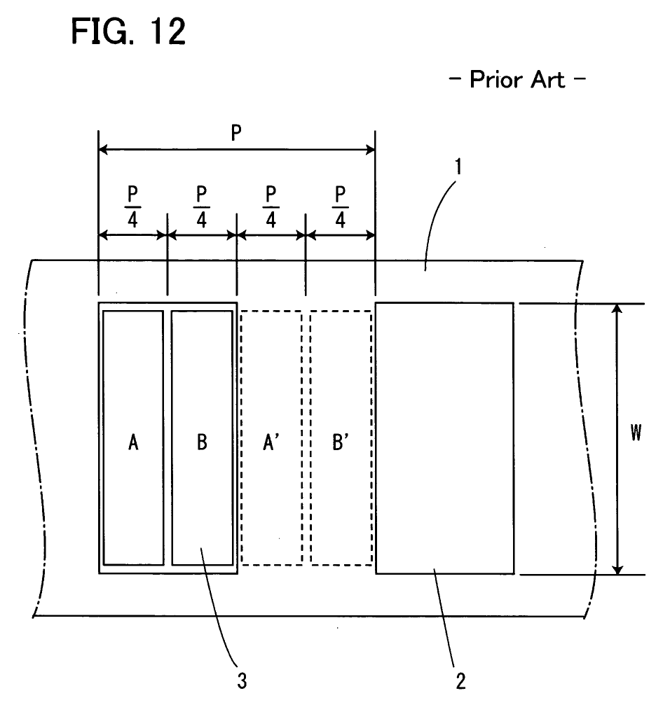

FIG. 13 illustrates signals of the optical encoder according to Japanese Patent Laid-Open Publication No. 59-040258;

FIG. 14 illustrates the structure of an optical encoder according to Japanese Patent Laid-Open Publication No. 61-292016; and

FIG. 15 illustrates signals of the optical encoder according to Japanese Patent Laid-Open Publication No. 61-292016.

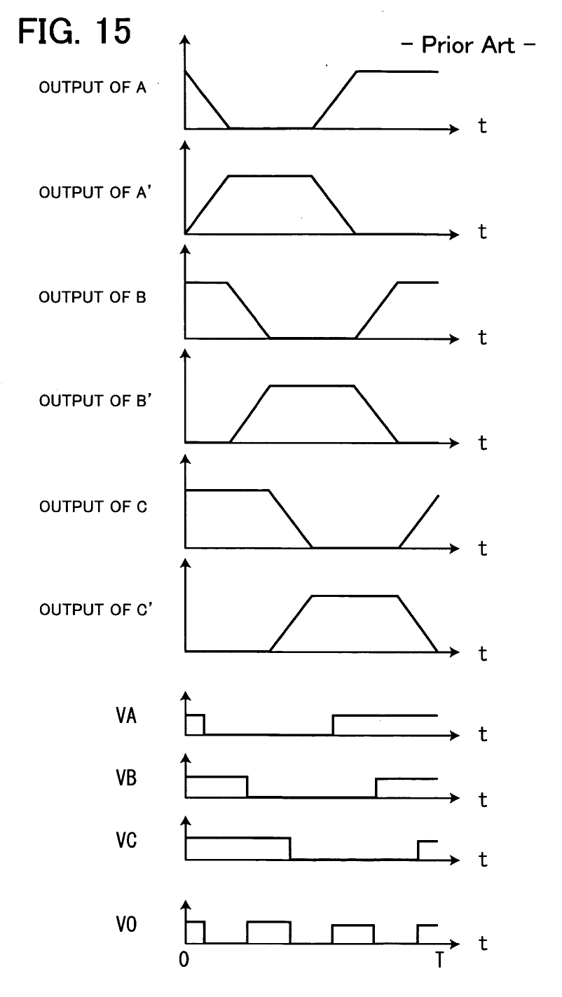

### DETAILED DESCRIPTION OF THE PREFERRED EMBODIMENTS

Hereinafter, embodiments of the present invention will be explained with reference to the attached drawings. The embodiments shown below are only a few specific examples of the present invention and the present invention will by no means be limited to the following embodiments.

### Embodiment 1

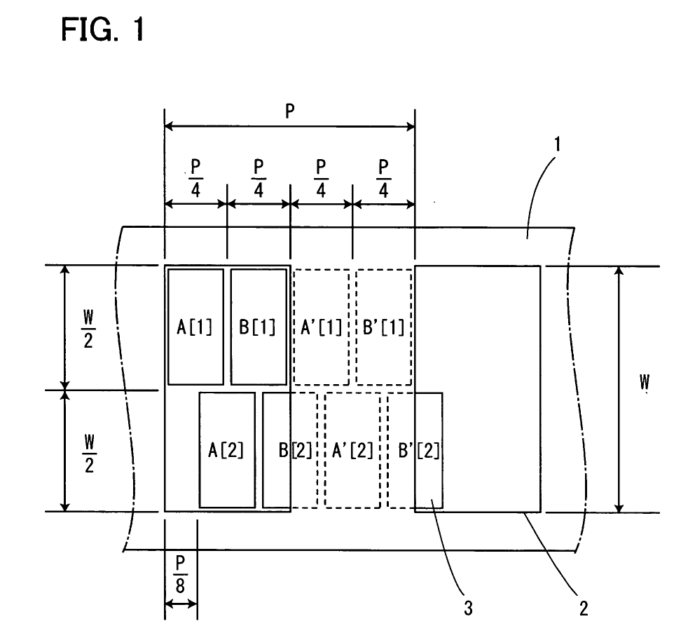

FIG. 1 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with two light-receiving blocks (the respective numerical values in this embodiment correspond to a case where it is assumed that I=1, J=2, M=1 according to fourth aspect). A light-receiving block on a first row in the direction perpendicular to the moving direction is provided with four light-receiving elements 3 (A[1], B[1], A′[1], B′[1]) arranged in series at close intervals in the moving direction and a light-receiving block on a second row in the direction perpendicular to the moving direction is provided with four light-receiving elements 3 (A[2], B[2], A′[2], B′[2]) arranged in series at close intervals in the moving direction. Here, the shape of each light-receiving element 3 is identical (the width in the moving direction is approximately P/4 and the width in the direction perpendicular to the moving direction is approximately W/2). Furthermore, the position of the light-receiving block on the second row in the direction perpendicular to the moving direction is shifted by P/8 in the moving direction and by W/2 in the direction perpendicular to the moving direction relative to the light-receiving block on the first row in the direction perpendicular to the moving direction.

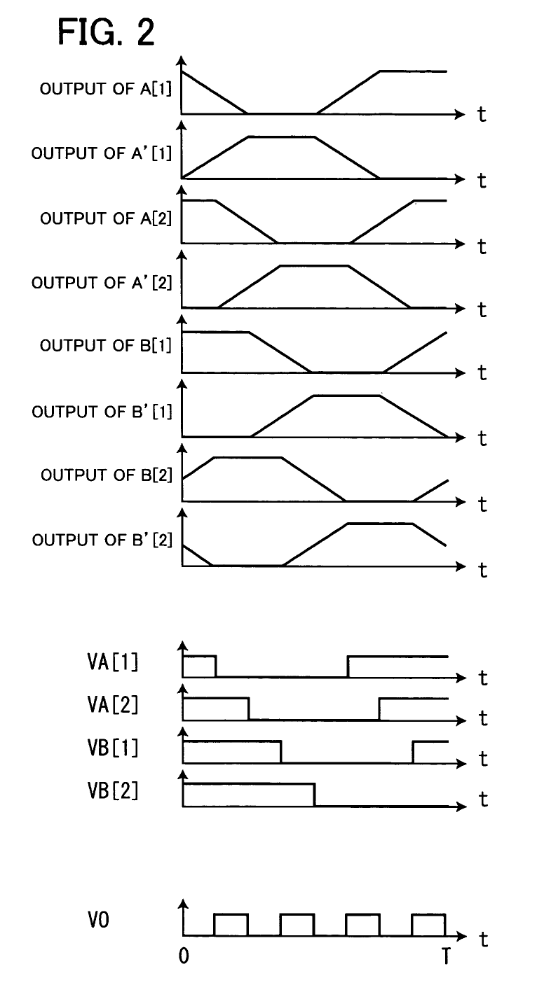

FIG. 2 shows signals obtained from the optical encoder having the structure in FIG. 1. Eight signals above are the outputs of the respective light-receiving elements 3 and have phases different from each other. From these eight signals, the following four signals are obtained. More specifically, VA[1] is obtained by subtracting the output of A′[1] from the output of A[1] and regarding the subtraction result as “1” if the value is positive and “0” otherwise. In the same way, VA[2] is obtained by subtracting the output of A′[2] from the output of A[2] and regarding the subtraction result as “1” if the value is positive and “0” otherwise, VB[1] is obtained by subtracting the output of B′[1] from the output of B[1] and regarding the subtraction result as “1” if the value is positive and “0” otherwise, and VB[2] is obtained by subtracting the output of B′[2] from the output of B[2] and regarding the subtraction result as “1” if the value is positive and “0” otherwise.

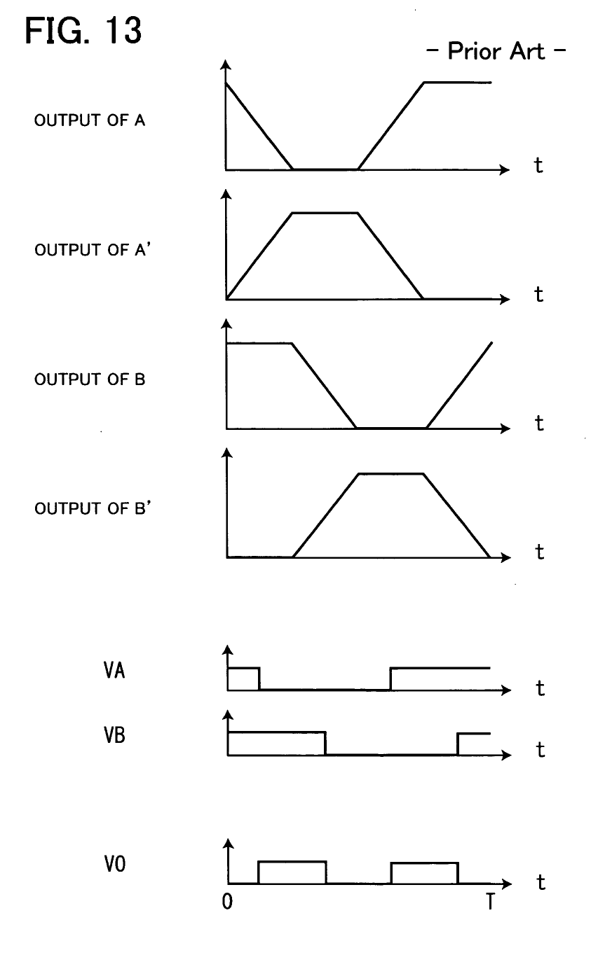

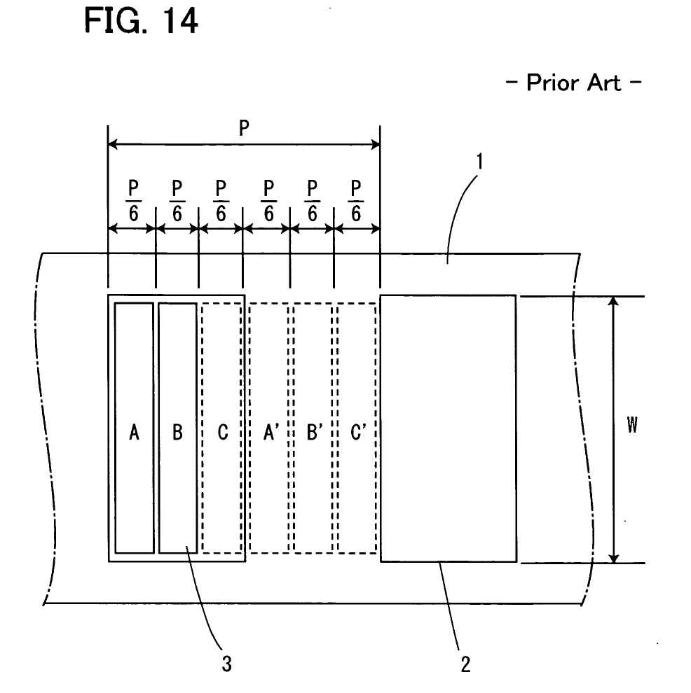

A signal VO at the bottom of FIG. 2 is a value obtained by XORing (taking EXCLUSIVE OR of) these decision values (VA[1], VA[2], VB[1], VB[2]). Four pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14).

### Embodiment 2

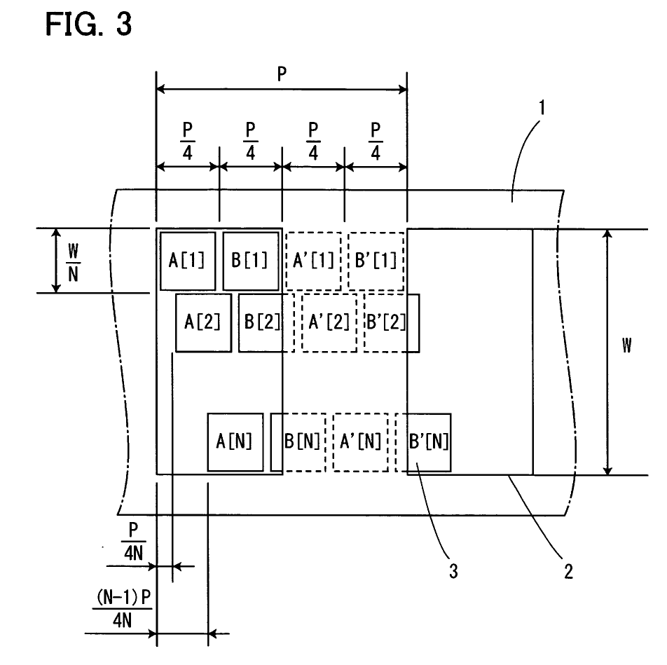

FIG. 3 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with N (N: integer of 2 or greater) light-receiving blocks (the respective numerical values in this embodiment correspond to a case where it is assumed that I=1, J=N, M=1 according to fourth aspect). When j is assumed to be an integer of 1 or greater and not greater than N, a light-receiving block on a jth row in a direction perpendicular to the moving direction is provided with four light-receiving elements 3 (A[j], B[j], A′[j], B′[j]) arranged in series at close intervals in the moving direction. Here, the shape of each light-receiving element 3 is identical (the width in the moving direction is approximately P/4 and the width in the direction perpendicular to the moving direction is approximately W/N). Furthermore, when j is assumed to be an integer of 2 or greater and not greater than N, the position of the light-receiving block on the jth row in the direction perpendicular to the moving direction is shifted by (j−1)×P/(4×N) in the moving direction and by (j−1)×W/N in the direction perpendicular to the moving direction relative to the light-receiving block on the first row in the direction perpendicular to the moving direction.

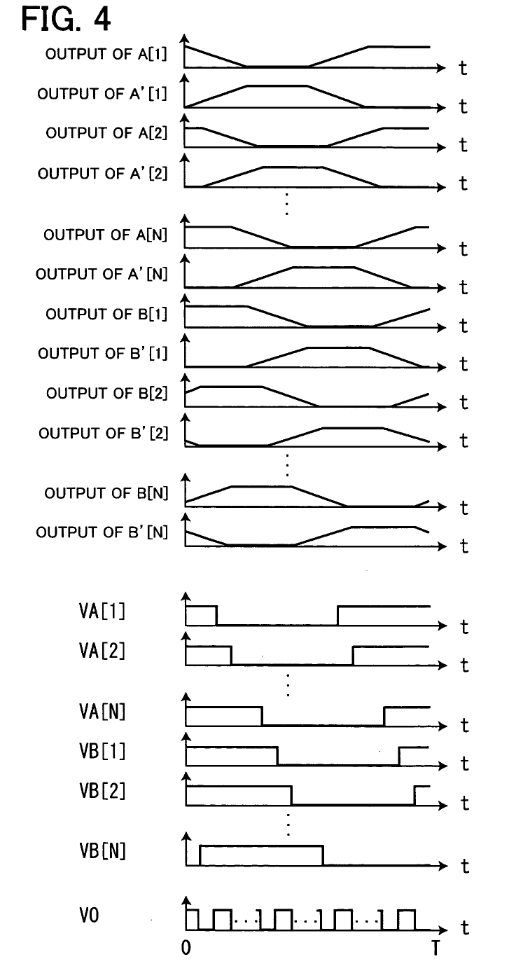

FIG. 4 shows signals obtained from the optical encoder having the structure in FIG. 3. (4×N) signals above are the outputs of the respective light-receiving elements 3 and have phases different from each other. From these (4×N) signals, the following (2×N) signals are obtained. More specifically, VA[j] is obtained by subtracting the output of A′[j] from the output of A[j] and regarding the subtraction result as “1” if the value is positive and “0” otherwise, and VB[j] is obtained by subtracting the output of B′[j] from the output of B[j] and regarding the subtraction result as “1” if the value is positive and “0” otherwise.

A signal VO at the bottom of FIG. 4 is a value obtained by XORing (taking EXCLUSIVE OR of) these decision values (VA[1], . . . , VA[N], VB[1], . . . , VB[N]). (2×N) pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14).

### Embodiment 3

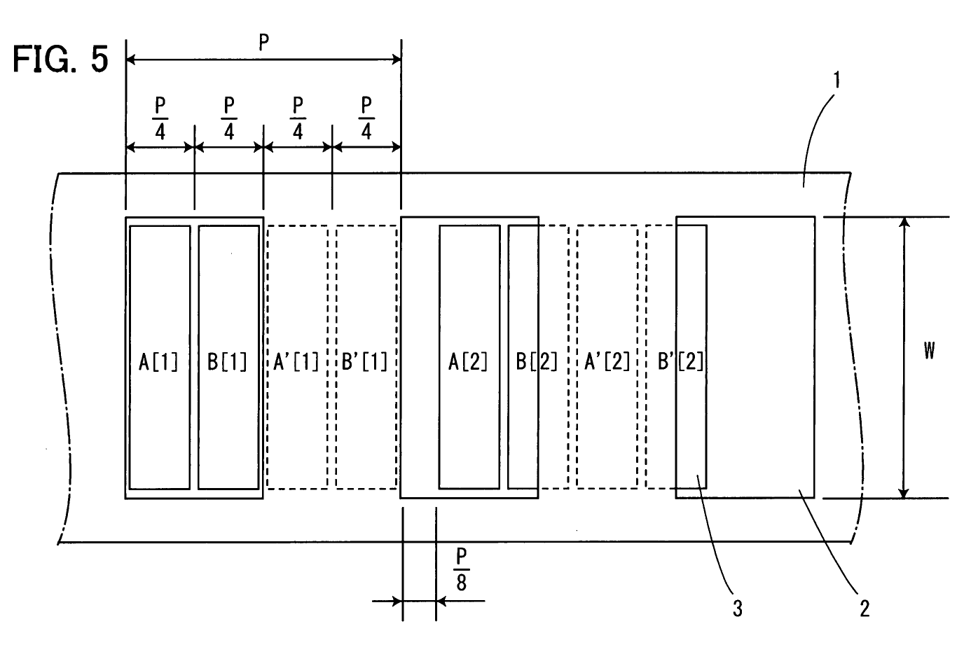

FIG. 5 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with two light-receiving blocks (the respective numerical values in this embodiment correspond to a case where it is assumed that I=2, J=1, M=1 according to fourth aspect). A light-receiving block on a first row in the moving direction is provided with four light-receiving elements 3 (A[1], B[1], A′[1], B′[1]) and a light-receiving block on a second row in the moving direction is provided with four light-receiving elements 3 (A[2], B[2], A′[2], B′[2]) arranged in series at close intervals in the moving direction. Here, the shape of each light-receiving element 3 is identical (the width in the moving direction is approximately P/4 and the width in the direction perpendicular to the moving direction is approximately W). Furthermore, the position of the light-receiving block on the second row in the moving direction is shifted by 9×P/8 in the moving direction relative to the light-receiving block on the first row in the moving direction.

Signals obtained from the optical encoder of the structure of FIG. 5 are shown in FIG. 2 (the waveforms of the signals obtained from the optical encoder of this embodiment are identical to those in Embodiment 1). Eight signals above are the outputs of the respective light-receiving elements 3 and have phases different from each other. From these eight signals, the following four signals are obtained. More specifically, VA[1] is obtained by subtracting the output of A′[1] from the output of A[1] and regarding the subtraction result as “1” if the value is positive and “0” otherwise. In the same way, VA[2] is obtained by subtracting the output of A′[2] from the output of A[2] and regarding the subtraction result as “1” if the value is positive and “0” otherwise, VB[1] is obtained by subtracting the output of B′[1] from the output of B[1] and regarding the subtraction result as “1” if the value is positive and “0” otherwise, and VB[2] is obtained by subtracting the output of B′[2] from the output of B[2] and regarding the subtraction result as “1” if the value is positive and “0” otherwise.

A signal VO at the bottom of FIG. 2 is a value obtained by XORing (taking EXCLUSIVE OR of) these decision values (VA[1], VA[2], VB[1], VB[2]). Four pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14).

### Embodiment 4

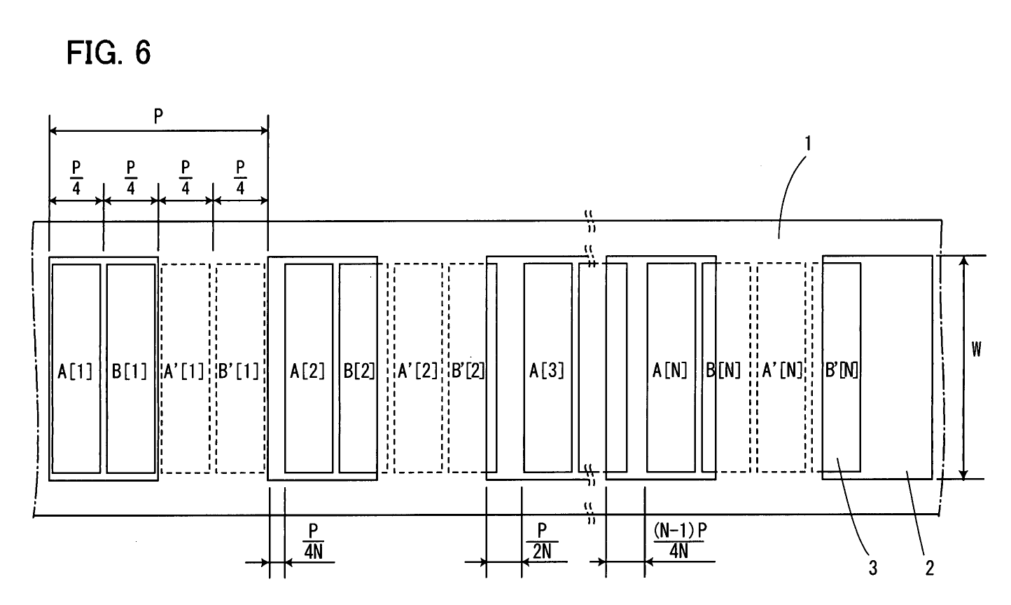

FIG. 6 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with N (N: integer of 2 or greater) light-receiving blocks (the respective numerical values in this embodiment correspond to a case where it is assumed that I=N, J=1, M=1 according to fourth aspect). When i is assumed to be an integer of 1 or greater and not greater than N, a light-receiving block on an ith row in the moving direction is provided with four light-receiving elements 3 (A[i], B[i], A′[i], B′[i]) arranged in series at close intervals in the moving direction. Here, the shape of each light-receiving element 3 is identical (the width in the moving direction is approximately P/4 and the width in the direction perpendicular to the moving direction is approximately W). Furthermore, when i is assumed to be an integer of 2 or greater and not greater than N, the position of the light-receiving block on the ith row in the moving direction is shifted by (i−1)×(4×N+1)×P/(4×N) in the moving direction relative to the light-receiving block on the first row in the moving direction.

FIG. 4 shows signals obtained from the optical encoder having the structure in FIG. 6 (the waveforms of the signals obtained from the optical encoder of this embodiment are identical to those in Embodiment 2). (4×N) signals above are the outputs of the respective light-receiving elements 3 and have phases different from each other. From these (4×N) signals, the following (2×N) signals are obtained. More specifically, when j is assumed to be an integer of 1 or greater and not greater than N, VA[i] is obtained by subtracting the output of A′[i] from the output of A[i] and regarding the subtraction result as “1” if the value is positive and “0” otherwise, and VB[i] is obtained by subtracting the output of B′[i] from the output of B[i] and regarding the subtraction result as “1” if the value is positive and “0” otherwise.

A signal VO at the bottom of FIG. 4 is a value obtained by XORing (taking EXCLUSIVE OR of) these decision values (VA[1], . . . , VA[N], VB[1], . . . , VB[N]). (2×N) pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14).

### Embodiment 5

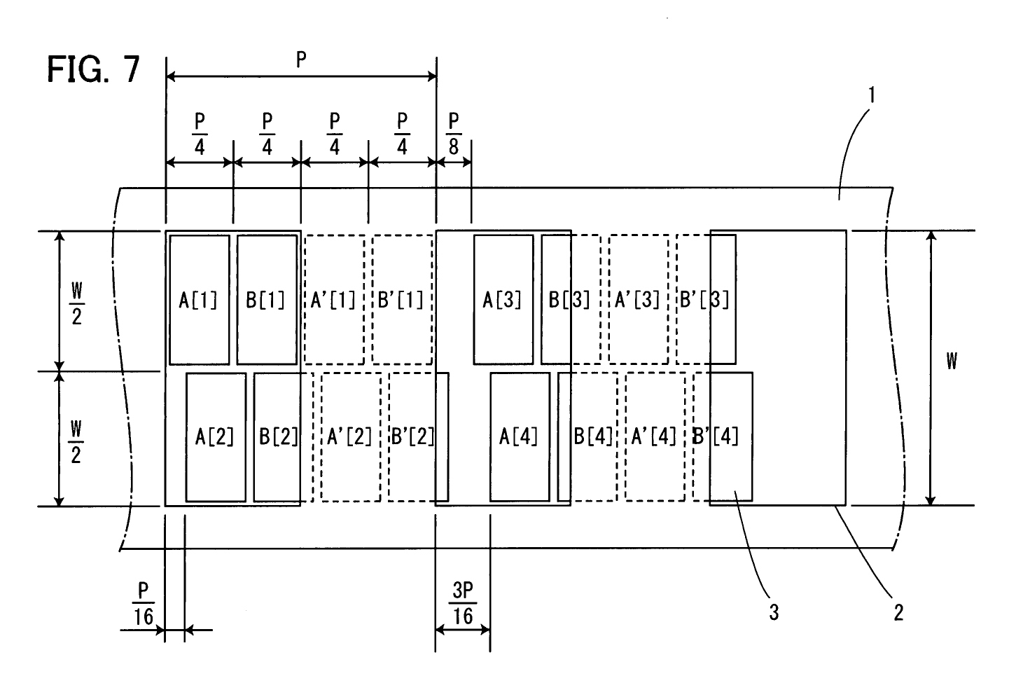

FIG. 7 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with four light-receiving blocks (the respective numerical values in this embodiment correspond to a case where it is assumed that I=2, J=2, M=1 according to fourth aspect). Assuming that i is an integer of 1 or greater and not greater than 2 and j is an integer of 1 or greater and not greater than 2, a light-receiving block on a ith row in the moving direction and on a jth row in the direction perpendicular to the moving direction is provided with four light-receiving elements 3 (A[k], B[k], A′[k], B′[k]) (here, k=(i−1)×2+j) arranged in series at close intervals in the moving direction. Here, the shape of each light-receiving element 3 is identical (the width in the moving direction is approximately P/4 and the width in the direction perpendicular to the moving direction is approximately W/2). Furthermore, the position of the light-receiving block on the first row in the moving direction and on the second row in the direction perpendicular to the moving direction is shifted by P/16 in the moving direction and by W/2 in the direction perpendicular to the moving direction relative to the light-receiving block on the first row in the moving direction and on the first row in the direction perpendicular to the moving direction, the position of the light-receiving block on the second row in the moving direction and on the first row in the direction perpendicular to the moving direction is shifted by 9×P/8 in the moving direction relative to the light-receiving block on the first row in the moving direction and on the first row in the direction perpendicular to the moving direction and the position of the light-receiving block on the second row in the moving direction and on the second row in the direction perpendicular to the moving direction is shifted by 19×P/16 in the moving direction and by W/2 in the direction perpendicular to the moving direction relative to the light-receiving block on the first row in the moving direction and on the first row in the direction perpendicular to the moving direction.

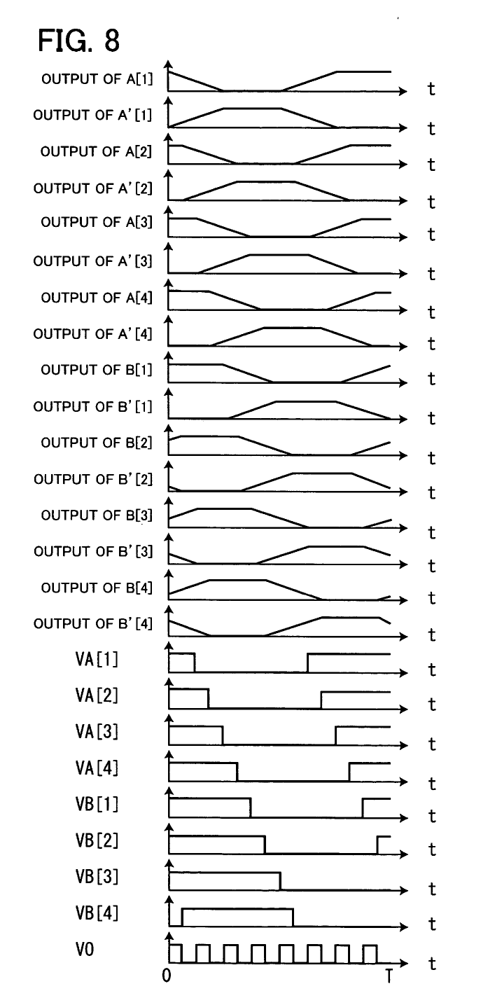

FIG. 8 shows signals obtained from the optical encoder having the structure of FIG. 7. Sixteen signals above are the outputs of the respective light-receiving elements 3 and have phases different from each other. From these sixteen signals, the following eight signals are obtained. More specifically, when k is assumed to be an integer of 1 or greater and not greater than 4, VA[k] is obtained by subtracting the output of A′[k] from the output of A[k] and regarding the subtraction result as “1” if the value is positive and “0” otherwise and VB[k] is obtained by subtracting the output of B′[k] from the output of B[k] and regarding the subtraction result as “1” if the value is positive and “0” otherwise.

A signal VO at the bottom of FIG. 8 is a value obtained by XORing (taking EXCLUSIVE OR of) these decision values (VA[1], VA[2], VA[3], VA[4], VB[1], VB[2], VB[3], VB[4]). Eight pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14).

### Embodiment 6

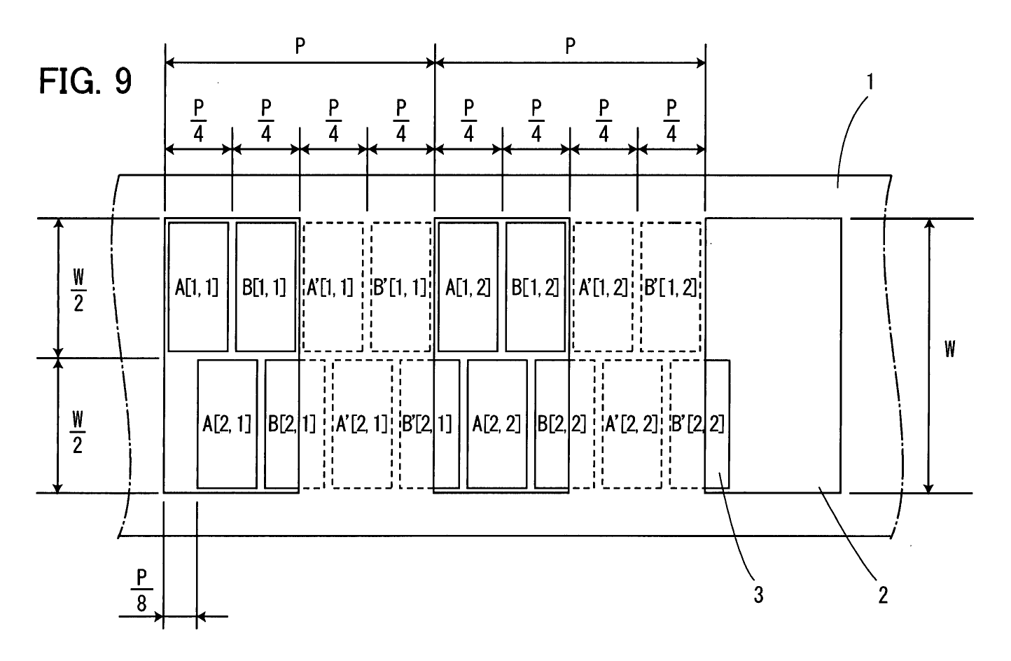

FIG. 9 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with two light-receiving blocks, each light-receiving block is provided with four light-receiving element groups and each light-receiving element group is made up of two light-receiving elements (the respective numerical values in this embodiment correspond to a case where it is assumed that I=1, J=2, M=2 according to fourth aspect). A light-receiving block on the first row in the direction perpendicular to the moving direction is provided with four light-receiving element groups (A[1], B[1], A′[1], B′[1]) arranged in series at close intervals in the moving direction and a light-receiving block on the second row in the direction perpendicular to the moving direction is provided with four light-receiving element groups (A[2], B[2], A′[2], B′[2]) arranged in series at close intervals in the moving direction. Here, when j is assumed to be an integer of 1 or greater and not greater than 2, a light-receiving element group A[j] is made up of a light-receiving element A[j,1] and a light-receiving element A[j,2], alight-receiving element group B[j] is made up of a light-receiving element B[j,1] and a light-receiving element B[j,2], alight-receiving element group A′[j] is made up of a light-receiving element A′[j,1] and a light-receiving element A′[j,2] and a light-receiving element group B′[j] is made up of a light-receiving element B′[j,1] and a light-receiving element B′[j,2]. Here, the shape of each light-receiving element 3 is identical (the width in the moving direction is approximately P/4 and the width in the direction perpendicular to the moving direction is approximately W/2). Moreover, the position of the light-receiving block on the second row in the direction perpendicular to the moving direction is shifted by P/8 in the moving direction and by W/2 in the direction perpendicular to the moving direction relative to the light-receiving block on the first row in the direction perpendicular the moving direction.

FIG. 2 shows signals obtained from the optical encoder having the structure in FIG. 9. Eight signals above are the outputs of each light-receiving element group and have phases different from each other. From these eight signals, the following four signals are obtained. More specifically, VA[1] is obtained by subtracting the output of A′[1] from the output of A[1] and regarding the subtraction result as “1” if the value is positive and “0” otherwise. In the same way, VA[2] is obtained by subtracting the output of A′[2] from the output of A[2] and regarding the subtraction result as “1” if the value is positive and “0” otherwise, VB[1] is obtained by subtracting the output of B′[1] from the output of B[1] and regarding the subtraction result as “1” if the value is positive and “0” otherwise and VB[2] is obtained by subtracting the output of B′[2] from the output of B[2] and regarding the subtraction result as “1” if the value is positive and “0” otherwise.

A signal VO at the bottom of FIG. 2 is a value obtained by XORing (taking EXCLUSIVE OR of) these decision values (VA[1], VA[2], VB[1], VB[2]). Four pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14). Furthermore, since each light-receiving element group is made up of a plurality of light-receiving elements which output signals of the same phase, the light-receiving area can be equivalently increased and the influence of noise or the like can be reduced.

### Embodiment 7

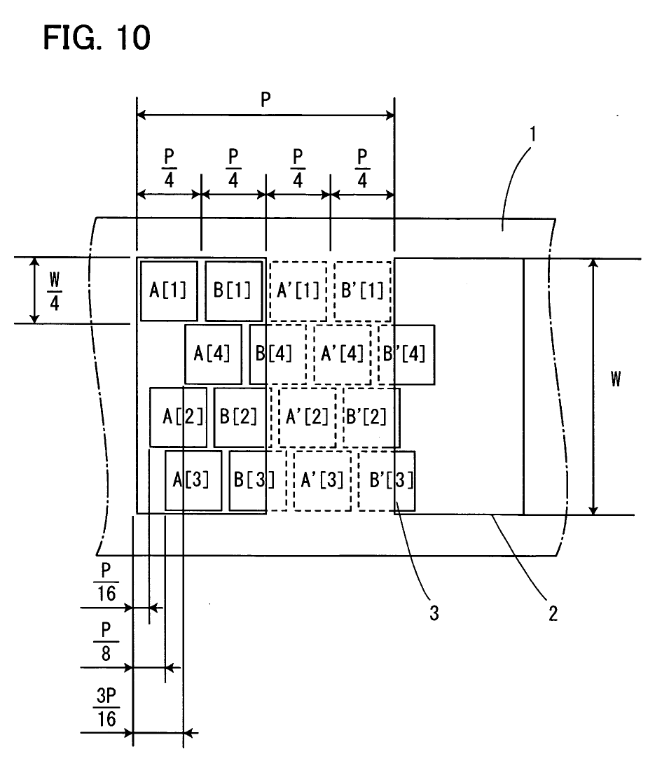

FIG. 10 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with four light-receiving blocks (the respective numerical values in this embodiment correspond to a case where it is assumed that J=4, M=1 according to second aspect). When j is assumed to be an integer of 1 or greater and not greater than 4, a jth light-receiving block is provided with four light-receiving elements 3 (A[j], B[j], A′[j], B′[j]) arranged in series at close intervals in the moving direction. Here, the shape of each light-receiving element 3 is identical (the width in the moving direction is approximately P/4 and the width in the direction perpendicular to the moving direction is approximately W/4). Furthermore, the position of a second light-receiving block is shifted by P/16 in the moving direction and by W/2 in the direction perpendicular to the moving direction relative to the first light-receiving block, a third light-receiving block is shifted by P/8 in the moving direction and by 3×W/4 in the direction perpendicular to the moving direction relative to the first light-receiving block in the moving direction and the position of a fourth light-receiving block is shifted by 3×P/16 and by W/4 in the direction perpendicular to the moving direction relative to the first light-receiving block (that is, when j is assumed to be an integer of 2 or greater and not greater than 4, the amount of shift in coordinates in the moving direction of the position of a jth light-receiving block is (j−1)×P/16 relative to the first light-receiving block).

FIG. 8 shows signals obtained from the optical encoder having the structure in FIG. 10. Sixteen signals above are the outputs of respective light-receiving elements 3 and have phases different from each other. From these sixteen signals, the following eight signals are obtained. More specifically, when j is assumed to be an integer of 1 or greater and not greater than 4, VA[j] is obtained by subtracting the output of A′[j] from the output of A[j] and regarding the subtraction result as “1” if the value is positive and “0” otherwise and VB[j] is obtained by subtracting the output of B′[j] from the output of B[j] and regarding the subtraction result as “1” if the value is positive and “0” otherwise.

A signal VO at the bottom of FIG. 8 is a value obtained by XORing (taking EXCLUSIVE OR of) these decision values (VA[1], VA[2], VA[3], VA[4], VB[1], VB[2], VB[3], VB[4]). Eight pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14).

### Embodiment 8

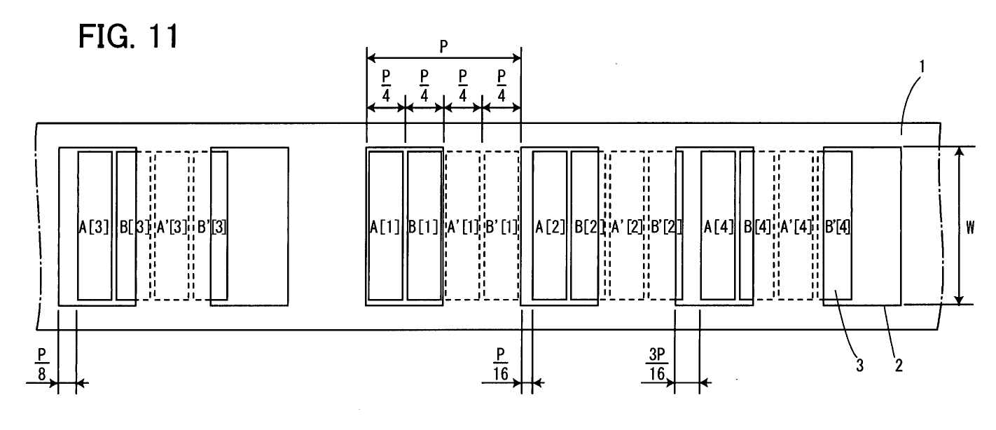

FIG. 11 shows the configuration of an optical encoder of this embodiment. In a moving section 1, a slit 2 having a width of P/2 in a moving direction and a width of W in a direction perpendicular to the moving direction is formed every predetermined pitch P in the moving direction.

A light-receiving section is provided with four light-receiving blocks (the respective numerical values in this embodiment correspond to a case where it is assumed that I=4, M=1 according to third aspect). When i is assumed to be an integer of 1 or greater and no greater than 4, a jth light-receiving block is provided with four light-receiving elements 3 (A[i], B[i], A′[i], B′[i]) arranged in series at close intervals in the moving direction. Here, the shape of each light-receiving element 3 is identical (the width in the moving direction is approximately P/4 and the width in the direction perpendicular to the moving direction is approximately W). Furthermore, the position of a second light-receiving block is shifted by 17×P/16 in the moving direction relative to a first light-receiving block, the position of a third light-receiving block is shifted by −15×P/8 in the moving direction relative to the first light-receiving block, the position of a fourth light-receiving block is shifted by 35×P/16 in the moving direction relative to the first light-receiving block (that is, assuming that i is an integer of 2 or greater and not greater than 4 and f(i) is an arbitrary integer in an ith light-receiving block, the amount of shift in coordinates in the moving direction of the position of the ith light-receiving block is f(i)×P+(i−1)×P/16 relative to the first light-receiving block and f(2)=1, f(3)=−2, f(4)=2).

FIG. 8 shows signals obtained from the optical encoder having the structure in FIG. 11. Sixteen signals above are the outputs of the respective light-receiving elements 3 and have phases different from each other. From these sixteen signals, the following eight signals are obtained. More specifically, when i is assumed to be an integer of 1 or greater and not greater than 4, VA[i] is obtained by subtracting the output of A′[i] from the output of A[i] and regarding the subtraction result as “1” if the value is positive and “0” otherwise and VB[i] is obtained by subtracting the output of B′[i] from the output of B[i] and regarding the subtraction result as “1” if the value is positive and “0” otherwise.

A signal VO at the bottom of FIG. 8 is a value obtained by XORing (taking EXCLUSIVE OR of) these decision values (VA[1], VA[2], VA[3], VA[4], VB[1], VB[2], VB[3], VB[4]). Eight pulses are obtained during a time T corresponding to a 1-slit pitch movement and resolution is improved without narrowing either the slit pitch P or the width of the light-receiving element 3 (only two pulses can be obtained with the optical encoder described in Japanese Patent Laid-Open Publication No. 59-040258 as shown in FIG. 13. Furthermore, the technology described in Japanese Patent Laid-Open Publication No. 61-292016 requires the width in the moving direction of light-receiving element 3 to be narrowed as shown in FIG. 14).

As described above, the present invention arranges a plurality of light-receiving blocks at positions calculated based on the phases of signals generated from the respective light-receiving elements, and can thereby provide an optical encoder which generates more signals of different phases than the conventional one. Moreover, the present invention can also provide an optical encoder with improved resolution without narrowing the slit pitch or width in the moving direction of the light-receiving element.

The effects of the present invention are as follows.

The present invention arranges a plurality of light-receiving blocks at positions calculated based on the phases of signals generated from the respective light-receiving elements, and can thereby provide an optical encoder which generates more signals of different phases than the conventional one. Furthermore, it is also possible to provide an optical encoder with improved resolution without narrowing either the slit pitch or width in the moving direction of the light-receiving element. Furthermore, it is possible to increase the light-receiving area equivalently and reduce influences of noise or the like by making up each light-receiving element group using a plurality of light-receiving elements which output signals of the same phase.

What is claimed is:

1. An optical encoder which causes a moving section provided with a plurality of slits to pass between a light-emitting section and a light-receiving section which are arranged opposite to each other and detects movement information on the moving section;
wherein the plurality of slits are formed so as to have a width of P/2 in a moving direction and a width of W in a direction perpendicular to the moving direction every predetermined pitch P in the moving direction,
when it is assumed that I is an integer of 1 or greater, J is an integer of 1 or greater and I×J≠1, the light-receiving section comprises (I×J) light-receiving blocks arranged on I rows in the moving direction and J rows in the direction perpendicular to the moving direction,
when M is assumed to be an integer of 1 or greater, each light-receiving block comprises:
a first light-receiving element group made up of M light-receiving elements arranged every predetermined pitch P in the moving direction;
a second light-receiving element group made up of M light-receiving elements arranged close to the M light-receiving elements of the first light-receiving element group at respective positions shifted by P/4 in the moving direction from the M light-receiving elements of the first light-receiving element group;
a third light-receiving element group made up of M light-receiving elements arranged close to the M light-receiving elements of the second light-receiving element group at respective positions shifted by P/4 in the moving direction from the M light-receiving elements of the second light-receiving element group;
a fourth light-receiving element group made up of M light-receiving elements arranged close to the M light-receiving elements of the third light-receiving element group at respective positions shifted by P/4 in the moving direction from the M light-receiving elements of the third light-receiving element group,
all the light-receiving elements of the optical encoder have an identical shape with a width in the moving direction being approximately P/4 and a width in the direction perpendicular to the moving direction being approximately W/J,
all the light-receiving element groups of the optical encoder output signals obtained by adding up output signals of the M light-receiving elements making up the light-receiving element groups, and
each light-receiving block is arranged at a position shifted in such a way that the phases of output signals of all the light-receiving element groups of the optical encoder differ from each other.

2. An optical encoder which causes a moving section provided with a plurality of slits to pass between a light-emitting section and a light-receiving section which are arranged opposite to each other and detects movement information on the moving section;
wherein the plurality of slits are formed so as to have a width of P/2 in a moving direction and a width of W in a direction perpendicular to the moving direction every predetermined pitch P in the moving direction,
when J is assumed to be an integer of 2 or greater, the light-receiving section comprises J light-receiving blocks arranged on one row in the moving direction and J rows in the direction perpendicular to the moving direction,
when M is assumed to be an integer of 1 or greater, each light-receiving block comprises:
a first light-receiving element group made up of M light-receiving elements arranged every predetermined pitch P in the moving direction;
a second light-receiving element group made up of M light-receiving elements-arranged close to the M light-receiving elements of the first light-receiving element group at respective positions shifted by P/4 in the moving direction from the M light-receiving elements of the first light-receiving element group;
a third light-receiving element group made up of M light-receiving elements arranged close to the M light-receiving elements of the second light-receiving element group at respective positions shifted by P/4 in the moving direction from the M light-receiving elements of the second light-receiving element group;
a fourth light-receiving element group made up of M light-receiving elements arranged close to the M light-receiving elements of the third light-receiving element group at respective positions shifted by P/4 in the moving direction from the M light-receiving elements of the third light-receiving element group,
all the light-receiving elements of the optical encoder have an identical shape with a width in the moving direction being approximately P/4 and a width in the direction perpendicular to the moving direction being approximately W/J,
all the light-receiving element groups of the optical encoder output signals obtained by adding up output signals of the M light-receiving elements making up the light-receiving element groups, and
when j is assumed to be an integer of 2 or greater and not greater than J, a jth light-receiving block is arranged at a position shifted by (j−1)×P/(4×J) in the moving direction relative to the first light-receiving block.

3. An optical encoder which causes a moving section provided with a plurality of slits to pass between a light-emitting section and a light-receiving section which are arranged opposite to each other and detects movement information on the moving section;
wherein the plurality of slits are formed so as to have a width of P/2 in a moving direction and a width of W in a direction perpendicular to the moving direction every predetermined pitch P in the moving direction,
when I is assumed to be an integer of 2 or greater, the light-receiving section comprises I light-receiving blocks arranged on I rows in the moving direction and one row in the direction perpendicular to the moving direction,
when M is assumed to be an integer of 1 or greater, each light-receiving block comprises:
a first light-receiving element group made up of M light-receiving elements arranged every predetermined pitch P in the moving direction;
a second light-receiving element group made up of M light-receiving elements arranged close to the M light-receiving elements of the first light-receiving element group at respective positions shifted by P/4 in the moving direction from the M light-receiving elements of the first light-receiving element group;
a third light-receiving element group made up of M light-receiving elements arranged close to the M light-receiving elements of the second light-receiving element group at respective positions shifted by P/4 in the moving direction from the M light-receiving elements of the second light-receiving element group;
a fourth light-receiving element group made up of M light-receiving elements arranged close to the M light-receiving elements of the third light-receiving element group at respective positions shifted by P/4 in the moving direction from the M light-receiving elements of the third light-receiving element group,
all the light-receiving elements of the optical encoder have an identical shape with a width in the moving direction being approximately P/4 and a width in the direction perpendicular to the moving direction being approximately W,
all the light-receiving element groups of the optical encoder output signals obtained by adding up output signals of the M light-receiving elements making up the light-receiving element groups, and
when it is assumed that i is an integer of 2 or greater and not greater than I and f(i) is an arbitrary integer in an ith light-receiving block, the ith light-receiving block is arranged at a position shifted by f(i)×P+(i−1)×P/(4×I) in the moving direction relative to the first light-receiving block.

4. An optical encoder which causes a moving section provided with a plurality of slits to pass between a light-emitting section and a light-receiving section which are arranged opposite to each other and detects movement information on the moving section;
wherein the plurality of slits are formed so as to have a width of P/2 in a moving direction and a width of W in a direction perpendicular to the moving direction every predetermined pitch P in the moving direction,
when it is assumed that I is an integer of 1 or greater, J is an integer of 1 or greater and I×J≠1, the light-receiving section comprises (I×J) light-receiving blocks arranged on I rows in the moving direction and J rows in the direction perpendicular to the moving direction,
when M is assumed to be an integer of 1 or greater, each light-receiving block comprises:
a first light-receiving element group made up of M light-receiving elements arranged every predetermined pitch P in the moving direction;
a second light-receiving element group made up of M light-receiving elements arranged close to the M light-receiving elements of the first light-receiving element group at respective positions shifted by P/4 in the moving direction from the M light-receiving elements of the first light-receiving element group;
a third light-receiving element group made up of M light-receiving elements arranged close to the M light-receiving elements of the second light-receiving element group at respective positions shifted by P/4 in the moving direction from the M light-receiving elements of the second light-receiving element group;
a fourth light-receiving element group made up of M light-receiving elements arranged close to the M light-receiving elements of the third light-receiving element group at respective positions shifted by P/4 in the moving direction from the M light-receiving elements of the third light-receiving element group,
all the light-receiving elements of the optical encoder have an identical shape with a width in the moving direction being approximately P/4 and a width in the direction perpendicular to the moving direction being approximately W/J,
all the light-receiving element groups of the optical encoder output signals obtained by adding up output signals of the M light-receiving elements making up the light-receiving element groups, and
when it is assumed that i is an integer of 1 or greater and not greater than I, j is an integer of 1 or greater and not greater than J and i×j≠1, the light-receiving block on an ith row in the moving direction and on a jth row in the direction perpendicular to the moving direction is arranged at a position shifted by ((4×I×M+1)×J×(i−1)+j−1)×P/(4×I×J) in the moving direction and by (j−1)×W/J in the direction perpendicular to the moving direction relative to the light-receiving block on the first row in the moving direction and on the first row in the direction perpendicular to the moving direction.

5. The optical encoder according to claim 1, wherein in each light-receiving block, “1” is set as a first decision value of the light-receiving block when a value obtained by subtracting an output signal of the third light-receiving element group from an output signal of the first light-receiving element group is positive and “0” is set otherwise, and “1” is set as a second decision value of the light-receiving block when a value obtained by subtracting an output signal of the fourth light-receiving element group from the output signal of the second light-receiving element group is positive and “0” is set otherwise, and
a value obtained by XORing the first decision values and the second decision values of all the light-receiving blocks is outputted.

6. The optical encoder according to claim 2, wherein in each light-receiving block, “1” is set as a first decision value of the light-receiving block when a value obtained by subtracting an output signal of the third light-receiving element group from an output signal of the first light-receiving element group is positive and “0” is set otherwise, and “1” is set as a second decision value of the light-receiving block when a value obtained by subtracting an output signal of the fourth light-receiving element group from the output signal of the second light-receiving element group is positive and “0” is set otherwise, and
a value obtained by XORing the first decision values and the second decision values of all the light-receiving blocks is outputted.

7. The optical encoder according to claim 3, wherein in each light-receiving block, “1” is set as a first decision value of the light-receiving block when a value obtained by subtracting an output signal of the third light-receiving element group from an output signal of the first light-receiving element group is positive and “0” is set otherwise, and “1” is set as a second decision value of the light-receiving block when a value obtained by subtracting an output signal of the fourth light-receiving element group from the output signal of the second light-receiving element group is positive and “0” is set otherwise, and
a value obtained by XORing the first decision values and the second decision values of all the light-receiving blocks is outputted.

8. The optical encoder according to claim 4, wherein in each light-receiving block, “1” is set as a first decision value of the light-receiving block when a value obtained by subtracting an output signal of the third light-receiving element group from an output signal of the first light-receiving element group is positive and “0” is set otherwise, and “1” is set as a second decision value of the light-receiving block when a value obtained by subtracting an output signal of the fourth light-receiving element group from the output signal of the second light-receiving element group is positive and “0” is set otherwise, and
a value obtained by XORing the first decision values and the second decision values of all the light-receiving blocks is outputted.
